(19) United States
(12) Patent Application Publication
(10) Pub. No.: US 2005/0198595 A1
(43) Pub. Date: Sep. 8, 2005

(54) State machine optimization system

(76) Inventor: Bryan Joseph Colvin SR., San Jose, CA (US)

Correspondence Address: Bryan Joseph Colvin Sr., 4182 Cherry Ave., San Jose, CA, 95118, US

(21) Appl. No.: 11/121,727

(22) Filed: May 5, 2005

Related U.S. Application Data
(62) Division of application No. 10/292,104, filed on Nov. 13, 2002.

(51) Int. Cl. G06F 17/50

(52) U.S. Cl. 716/2; 716/3; 716/18

(57) ABSTRACT

This invention details a process whereby state assignments and decode logic of a state machine can be mapped to an optimized representation. Optimization may constitute a reduction of gates, an increase of speed, or a reduction of power utilization. Optimization is particularly important when implementing timing systems. A timing system is one of many possible configurations of a state machine. Design engineers are under extreme time pressures; an optimal implementation requires an extensive amount of time. What typically is implemented is the quickest possible solution. Current HDL synthesizers are constrained by what they are given, so the most optimal solution is rarely achieved. A program can be created to examine a plethora of different implementation possibilities and choose the one that creates the least amount of gates. Therefore, not only does the designer save a great deal of time, the design is also highly optimized.

### FIELD OF THE INVENTION

The present invention relates to logic synthesis, which is used in the EDA (Electronic Design Automation) industry. Persons using this invention constitute electronic design engineers who design ASIC and FPGA circuits.

### DISCLOSURE OF INVENTION

As this is a divisional patent, all material is disclosed in the application entitled “HDL Timing Generator”. See application Ser. No. 10/292,104.

1. A state machine optimization system comprising:
a logic evaluation function generator means; and
a memory table containing numbers representing the next state of the said state machine; and
a plurality of memory tables containing numbers representing the next state of the state machine associated with the activation of a control signal which said control signal replaces the next state with the said control variable number state; and
a memory table comprising a number mapping the said next state number with a different state number; and
a plurality of state mapping methods which create an optimized table of mapped states of the said state machine; and
a swapping function which systematically exchanges numbers contained in the said mapped memory table whereby the said logic evaluation function evaluates both an optimized state map and an optimized output decoder which said swapping function is executed repeatedly on each state thereby optimizing the number returned by the said logic evaluation function and creating both an optimized state assignment and an optimized output decoder for the said state machine.

2. The optimized state machine as defined in claim 1 where the output decode of the said state machine combines one or more states of the said state machine and forms one or more signals which said signals constitute a timing system.

3. The timing system as defined in claim 2 where one or more output signals of the state machine map directly to one or more of the storage elements used in the said state machine thereby eliminating decode logic for each output signal that was mapped.

4. The storage element of claim 3 being implemented by a flip-flop.

5. The optimized state machine as defined in claim 1 which uses an input file describing a timing system which said timing system uses text characters comprising a multiplicity of dash and underscore characters and optionally uses other symbols representing control signals where the said dash characters represents the high state and the underscore characters represents the low state of a timing system.

6. The input file of claim 5 that uses a subroutine of a source code program implementing the optimized state machine of claim 1 whereby the subroutine interprets the said input file by directly using a string representing one or more signals of the said timing system whereby the said source code program is compiled together with the said input file.

7. The subroutine of claim 6 being contained within a class object of an object oriented language.

8. The object oriented language of claim 7 whereby the said language is interpreted by a logic synthesis program whereby the said input file gets processed and generates a timing system.
